(19) United States
(12) Patent Application Publication
(10) Pub. No.: US 2021/0191514 A1
(43) Pub. Date: Jun. 24, 2021

(54) Virtual Reality to Reality System

(71) Applicant: Catmasters LLC, Pasadena, TX (US)

(72) Inventor: Emir Zahirovic, Copenhagen NV (DK)

(21) Appl. No.: 17/125,815

(22) Filed: Dec. 17, 2020

Related U.S. Application Data
(60) Provisional application No. 62/949,827, filed on Dec. 18, 2019.

(51) Int. Cl. G06F 3/01; G06T 19/00; G06T 17/00

(52) U.S. Cl. CPC G06F 3/014; G06T 2207/10028; G06T 17/00; G06T 19/006

(57) ABSTRACT

A method and system are invented to display and control objects in an operational zone through a virtual reality (VR) environment using a central controller. The central controller can instantly and continuously acquire and process the data for objects in the operational zone, which includes point clouds, video streaming data, geographical data, superimposed mesh data, etc. Subsequently, the operational zone is displayed in a VR display system, creating a live and vivid three-dimensional (3D) VR for the user. Additionally, the objects in the operational zone can be controlled and operated by the user with various VR tools that are connected to the objects. Thus, the method not only offers the user a VR, but also eliminates the need to place the user in hazardous work areas. Further, the method allows the user to use a personal computing (PC) device to efficiently control the operational zone through the VR.

The current application claims a priority to the U.S. Provisional Patent application Ser. No. 62/949,827 filed on Dec. 18, 2019.

### FIELD OF THE INVENTION

The present invention relates generally to an interactive virtual reality (VR) system. More specifically, the present invention relates to a VR system for use in a physical workspace to manipulate real objects by controlling virtual representation of those objects.

### BACKGROUND OF THE INVENTION

There is an increasing demand for systems and methods that enable virtual reality (VR) to control real-world objects including machines, equipment, devices, tools, vehicles, etc. Conventional industrial control technologies are becoming increasingly complex. Workers and users in various industries can encounter a large amount of work under poor conditions, operating risk, and other shortcomings. For example, workers can be in direct contact with high voltage in high altitudes. Some medical procedures involve creating a number of small incisions in a patient with surgical instruments. Moreover, in petroleum refineries, assembly plants, or other complex facilities, training personnel on operation and maintenance tasks can be very expensive and risky.

In recent years, VR has seen great success in overcoming such problems. The VR experience is very similar to the real-world experience in a sense of space and object sensing. All objects in the VR world can be computer generated, and a user can be “immersed” in the computer-generated space via VR visual technologies. In addition, augmented reality and mixed reality are variations of VR in which the real and virtual worlds are integrated.

Most of the existing VR systems, however, are designed for training, presentation, or marketing purposes. Currently, these VR systems and technologies do not include a process to transfer control information to the real world to facilitate any changes or controls in VR. Thus, there is a need to develop a VR system that can control real-world devices and system components so users can receive training and avoid risks or dangerous and/or adverse situations when working on hazardous operational zones.

The present invention aims to solve the aforementioned problems, issues, and shortcomings by improving conventional VR systems and methods through an innovative system designed to provide a new form of VR in which the real world is controlled by the user in the virtual world.

### SUMMARY OF THE INVENTION

The present invention offers a method and system that displays objects in an operational zone of reality to a user who is situated inside a virtual reality (VR) environment in or outside the operational zone using a central controller. Using various sensors, cameras, and controls in a control system deployed in the operational zone, the central controller can instantly and continuously capture/monitor the objects in reality. Simultaneously, the central controller acquires and processes the data acquired for the operational zone, which includes point clouds, video streaming data, geographical data, superimposed mesh data, etc. Subsequently, the processed data is displayed and/or projected to a VR display system, thus creating a live and vivid three-dimensional (3D) VR environment for the user.

Using various tools for viewing and controlling the objects in the operational zone through the VR display system in the VR environment, the method of the present invention provides complete control to the user. Thus, objects including, but not limited to, robots, equipment, machinery, tools, vehicles, hardware, etc., in the operational zone of real world can be controlled and operated by the user in the VR environment to eliminate the need to place people and/or users in hazardous working areas. Additionally, the method is fully accessible and controllable via a network including, but not limited to, intranet and Internet, so a user can be located on or off the operational zone. Further, the method provides at least one remote server that manages the central controller and a corresponding personal computing (PC) device of the user so that an efficient and effective VR access to and control of the operational zone in reality can be achieved.

### BRIEF DESCRIPTION OF THE DRAWINGS

FIG. 1 is a system diagram of the virtual reality to reality (VR2R) system of the present invention.

FIG. 2 is a flowchart of the overall process of the VR2R method of the present invention.

FIG. 3 is a flowchart of a sub-process for controlling objects of the VR2R method of the present invention.

FIG. 4 is a flowchart of an alternative embodiment of the sub-process for controlling objects of the VR2R method of the present invention.

FIG. 5 is a flowchart of another embodiment of the sub-process for controlling objects of the VR2R method of the present invention.

FIG. 6 is a flowchart of a sub-process for user control in virtual reality (VR) of the VR2R method of the present invention.

FIG. 7 is a flowchart of an alternative embodiment of the sub-process for user control in VR of the VR2R method of the present invention.

FIG. 8 is a flowchart of another embodiment of the sub-process for user control in VR of the VR2R method of the present invention.

FIG. 9 is a flowchart of a sub-process for providing a processing module of the VR2R method of the present invention.

FIG. 10 is a flowchart of a sub-process for VR display control of the VR2R method of the present invention.

FIG. 11 is a flowchart of an alternative embodiment of the sub-process for VR display control of the VR2R method of the present invention, wherein a plurality of audio devices is provided.

FIG. 12 is a flowchart of another embodiment of the sub-process for VR display control of the VR2R method of the present invention, wherein a plurality of viewing devices is provided.

FIG. 13 is a flowchart of another embodiment of the sub-process for VR display control of the VR2R method of the present invention, wherein a plurality of projection devices is provided.

FIG. 14 is a system diagram showing one embodiment of the VR2R method and system of the present invention.

FIG. 15 is a flowchart showing one embodiment of a reality input step of the VR2R method of the present invention.

FIG. 16 is a flowchart showing one embodiment of an information exchange step of the VR2R method of the present invention.

FIG. 17 is a flowchart showing one embodiment of a VR representation step of the VR2R method of the present invention.

FIG. 18 is a flowchart showing information flow of the VR2R method of the present invention.

### DETAIL DESCRIPTIONS OF THE INVENTION

All illustrations of the drawings are for the purpose of describing selected versions of the present invention and are not intended to limit the scope of the present invention.

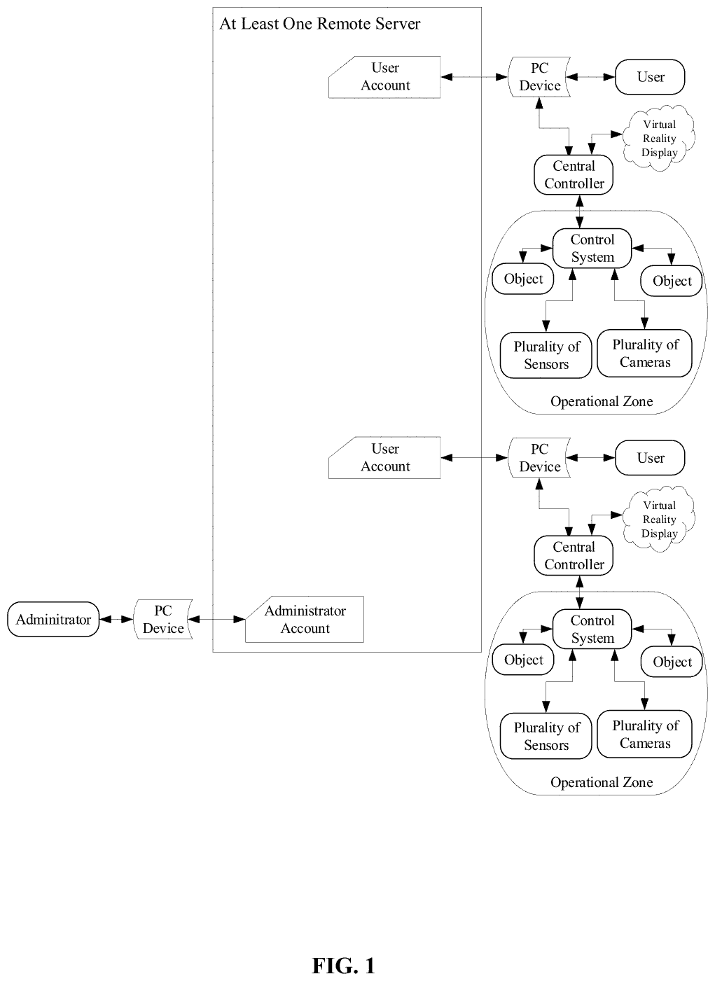

As can be seen in FIG. 1 to FIG. 18, the present invention comprises a method and system that displays and controls objects in an operational zone through a virtual reality (VR) system. More specifically, the present invention provides a method and system by which machinery, tools, vehicles, and hardware of any operational zone in the real world can be controlled and operated using a virtual reality (VR) to eliminate the need to place people and/or users in hazardous working areas. The method and system of the present invention is fully accessible and controllable via a network including, but not limited to, intranet and Internet, so a user can be located on or off the operational zone.

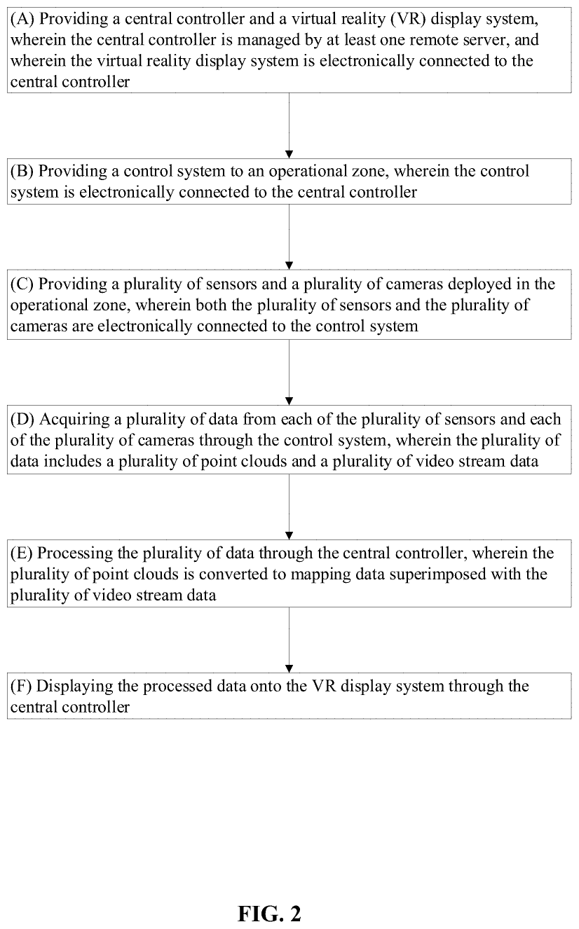

As can be seen in FIG. 1 and FIG. 2, the method of the present invention provides a central controller and a VR display system, wherein the central controller is managed by at least one remote server, and wherein the VR display system is electronically connected to the central controller in Step A. The at least one remote server is used to manage the VR display and control method of the present invention. The at least one remote server can be managed through an administrator account by an administrator as seen in FIG. 1. The administrator who manages the remote server includes, but is not limited to, owner, service provider, manager, technician, engineer, system engineer, system specialist, software engineer, IT engineer, IT professional, IT manager, IT consultant, service desk professional, service desk manager, consultant, executive officer, chief operating officer, chief technology officer, chief executive officer, president, cellular provider, network provider, network administrator, company, corporation, organization, etc. Moreover, the remote server is used to execute a number of internal software processes and store data for the present invention. The software processes may include, but are not limited to, server software programs, web-based software applications or browsers embodied as, for example, but not limited to, websites, web applications, desktop applications, cloud applications, and mobile applications compatible with a corresponding user PC device. Additionally, the software processes may store data into internal databases and communicate with external databases, which may include, but are not limited to, map databases, object point cloud databases, sensors databases, cameras databases, equipment databases, databases maintaining data about PC devices, databases maintaining machines/devices/tools/robots, databases maintaining operating parameters/data for equipment/machines/devices/tools/robots, etc. The interaction with external databases over a communication network may include, but is not limited to, the Internet.

Additionally, the method provides a control system to an operational zone, wherein the control system is electronically connected to the central controller in Step B. An operational zone is where actual tasks, motions, status of objects occur in reality. The operational zone includes, but is not limited to, job site, field work site, indoors/outdoors facilities, buildings, fields, farms, etc. The control system is deployed in the operational zone for controlling all objects in the operational zone. Additionally, the control system may include, but is not limited to, sensors, cameras, actuators, tools, robots, control modules, control units, programmable logic controls (PLC), motor controls, step motors, electrical controls, electronic controls, hydraulic controls, computer controls, microcontrollers, etc. Further, the method provides a plurality of sensors and a plurality of cameras deployed in the operational zone, wherein both the plurality of sensors and the plurality of cameras are electronically connected to the control system in Step C. The plurality of sensors resides in the operational zone and includes, but is not limited to, location sensor, geographical sensor, orientation sensor, velocity sensor, distance sensor, proximity sensor, temperature sensor, relative humidity sensor, sound sensor, ultrasound sensor, radar, laser sensor, light sensor, color sensor, pressure sensor, force sensor, light detection and ranging (LiDAR) sensor, three-dimensional (3D) point cloud sensor, metrological sensor, topographical sensor, etc. Further, the plurality of cameras also resides in the operational zone and includes, but is not limited to, 3D camera, 360° camera, video camera, webcam, surveillance camera, point cloud camera, video streaming device, image scanning device, 3D scanner, 3D photogrammetry scanning device, etc.

Next, the method of the present invention acquires a plurality of data from each of the plurality of sensors and each of the plurality of cameras through the control system, wherein the plurality of data includes a plurality of point clouds and a plurality of video stream data in Step D. Subsequently, the method processes the plurality of data through the central controller, wherein the plurality of point clouds is converted to mapping data superimposed with the plurality of video stream data (Step E), and displays the processed data onto the VR display system through the central controller (Step F). The each of the plurality of point clouds acquired may comprise a plurality of data points in space, which represents a 3D shape of one of the plurality of objects in the operational zone. In one embodiment of the present invention, each of the plurality of point clouds may be superimposed with one set of video stream data by the central controller to product a 3D live representation of one of the plurality of object in the operating zone using various technologies, including, but not limited to, 3D visualization, animation, 3D rendering, mass customization, digital elevation modeling, triangular mesh modeling, triangulation, polygon meshing, surface reconstruction, etc.

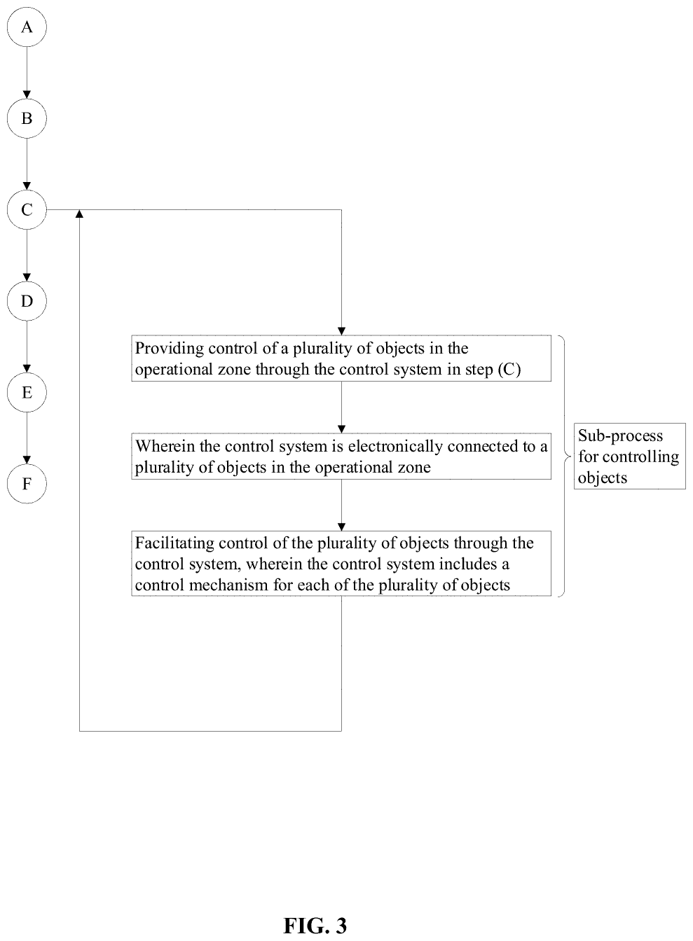

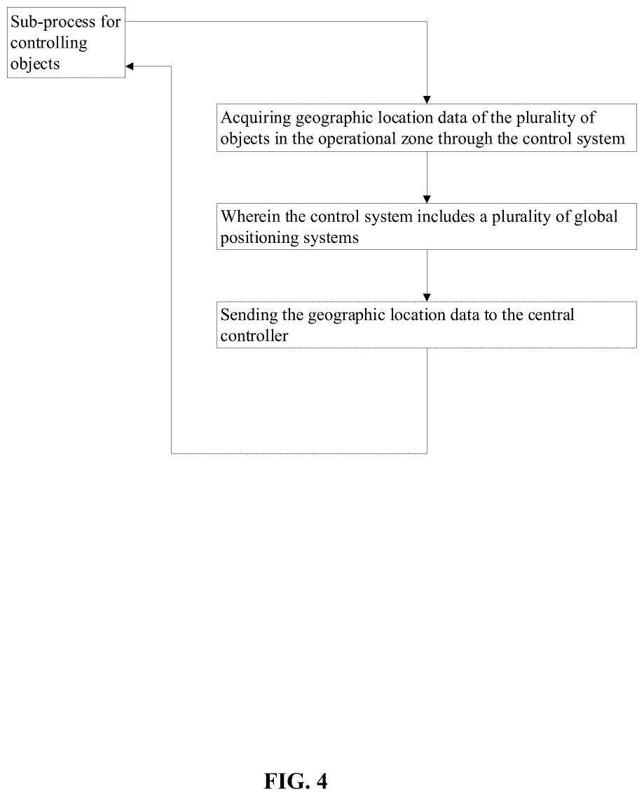

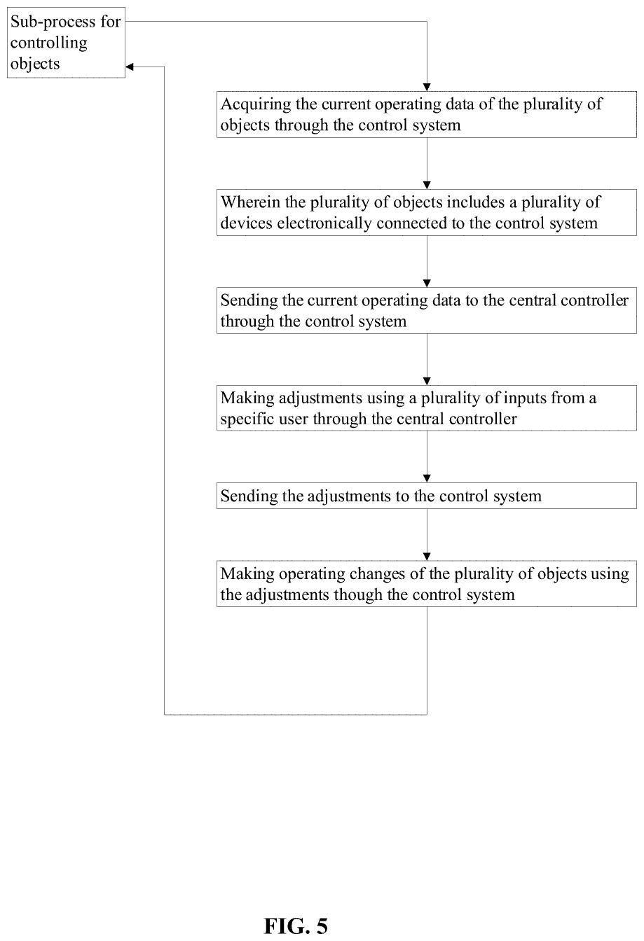

As can be seen in FIG. 3 and FIG. 14 to FIG. 18, the method of the present invention provides a sub-process for controlling objects in the operational zone. More specifically, the method provides control of a plurality of objects in the operational zone through the control system in Step C, wherein the control system is electronically connected to a plurality of objects in the operational zone. Subsequently, the method facilitates control of the plurality of objects through the control system, wherein the control system includes a control mechanism for each of the plurality of objects. As can be seen in FIG. 4, in an alternative embodiment of the present invention, the method acquires geographic location data of the plurality of objects in the operational zone through the control system, wherein the control system includes a plurality of global positioning systems. Subsequently, the method sends the geographic location data to the central controller. As can be seen in FIG. 5, in another embodiment of the present invention, the method acquires the current operating data of the plurality of objects through the control system, wherein the plurality of objects includes a plurality of devices electronically connected to the control system. Then the method sends the current operating data to the central controller through the control system. Subsequently, the method makes adjustments using a plurality of inputs from a specific user through the central controller. Additionally, the method sends the adjustments to the control system and makes operating changes of the plurality of objects using the adjustments though the control system. The plurality of objects may include, but is not limited to, a plurality of pieces of equipment, tool, motor vehicle, tool, device, machine, apparatus, controller, and any other suitable object.

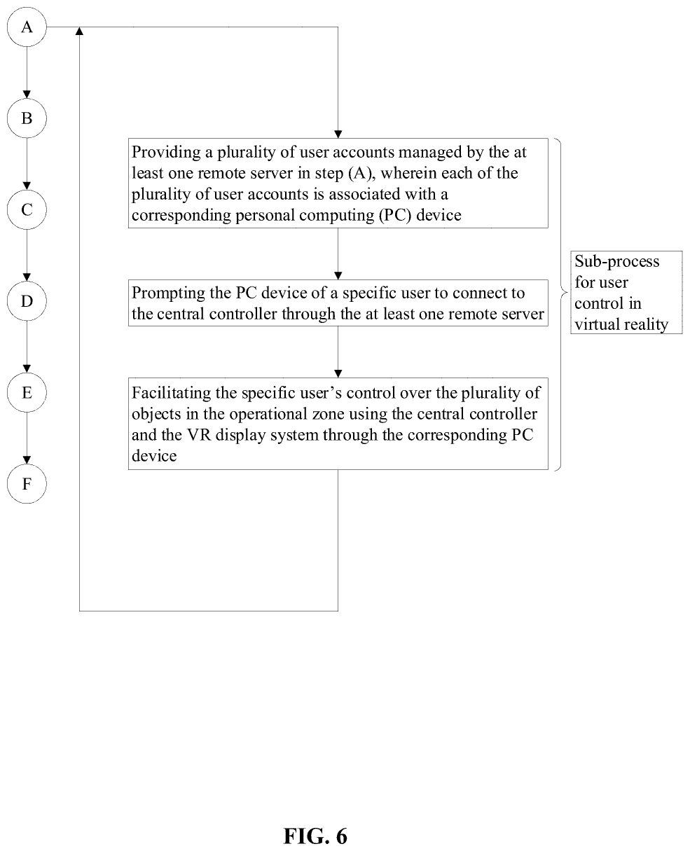

As can be seen in FIG. 6 and FIG. 14 to FIG. 18, the method of the present invention provides a sub-process for controlling objects in the operational zone by the specific user who is situated in a VR environment provided by the present invention. More specifically, the method provides a plurality of user accounts managed by the at least one remote server in Step A, wherein each of the plurality of user accounts is associated with a corresponding personal computing (PC) device. Additionally, the method prompts the PC device of a specific user to connect to the central controller through the at least one remote server. Subsequently, the method facilitates the specific user's control over the plurality of objects in the operational zone using the central controller and the virtual reality display system through the corresponding PC device. The corresponding PC device allows a user to interact with the present invention and can be, but is not limited to, phone, cellular phone, smartphone, smart watch, cloud PC, cloud device, network device, personal digital assistant (PDA), laptop, desktop, server, terminal PC, or tablet PC, etc. The users of the user accounts may include relevant parties such as, but are not limited to, individuals, consumers, computer professionals, information technology (IT) professions, engineers, consultants, VR game players, workers, labor force professionals, managers, executives, business owners, supervisors, technicians, machine/equipment operators, tradesmen, officials, companies, corporations, network companies, cellular companies, government entities, administrators, etc.

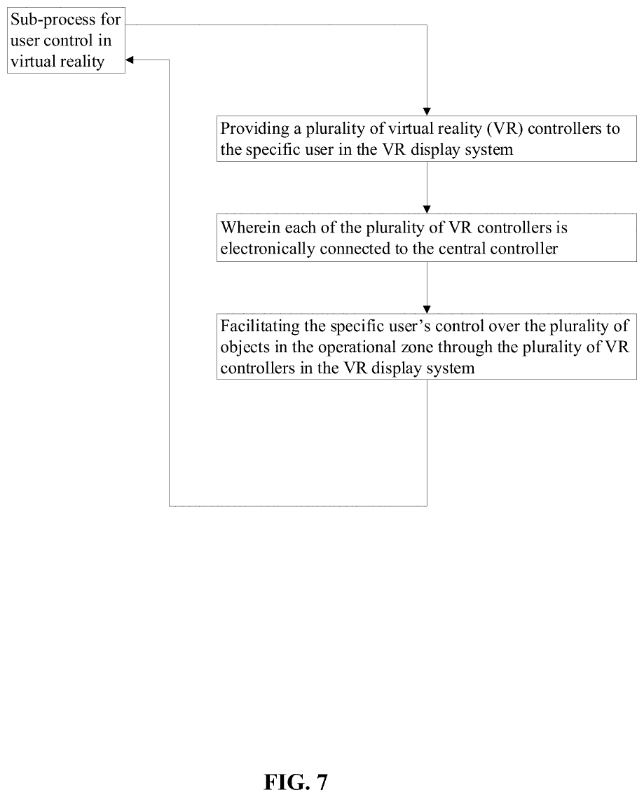

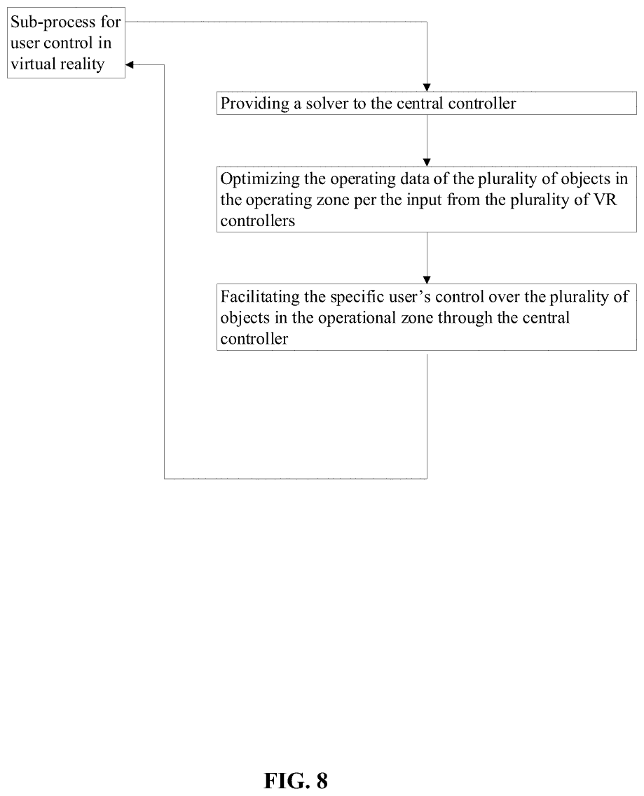

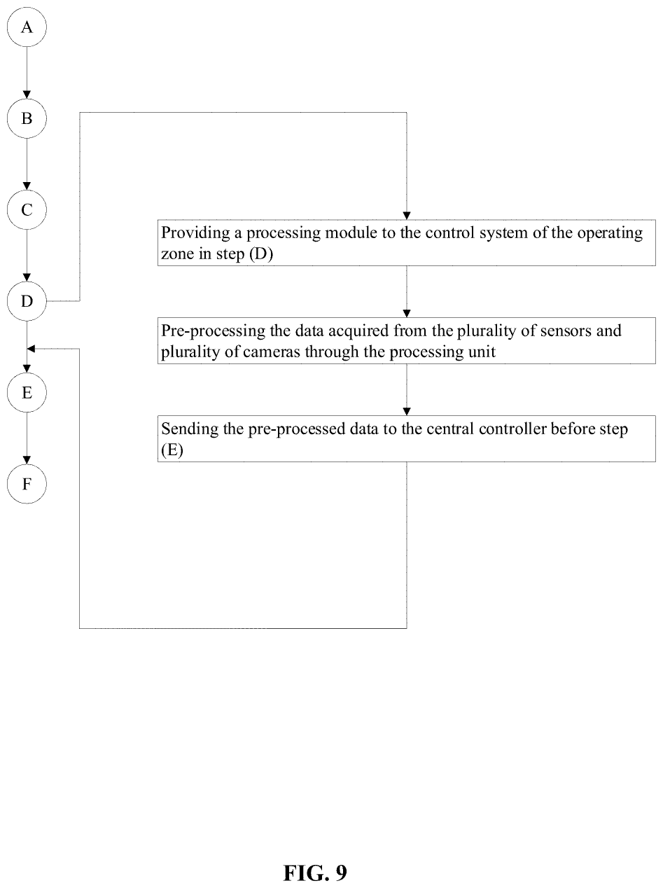

As can be seen in FIG. 7, in an alternative embodiment, the method provides a plurality of virtual reality (VR) controllers to the specific user in the VR display system, wherein each of the plurality of VR controllers is electronically connected to the central controller. Subsequently, the method facilitates the specific user's control over the plurality of objects in the operational zone through the plurality of VR controllers in the VR display system. The plurality of VR controllers of the present invention may include, but is not limited to, a plurality of wired gloves, tools, touchscreen controls, buttons, sliders, joysticks, VR gaming consoles, and any other suitable controls. As can be seen in FIG. 8, in another embodiment, the method provides a solver to the central controller to optimize the operating data of the plurality of objects in the operating zone per the input from the plurality of VR controllers. Subsequently, the method facilitates the specific user's control over the plurality of objects in the operational zone through the central controller. The solver may reside in the central controller and include, but is not limited to, algorisms, signal processing modules, data analysis modules, parameter optimization models, status analyzer, position/orientation analyzer, etc. As can be seen in FIG. 9, in another embodiment, the method provides a processing module to the control system of the operating zone in Step D to pre-process the data acquired from the plurality of sensors and plurality of cameras through the processing unit. Subsequently, the method sends the pre-processed data to the central controller before Step E. The processing module reside in the control system and include, but is not limited to, computing algorisms, signal and data analysis modules, parameter optimization models, status analyzer, position/orientation analyzer, etc.

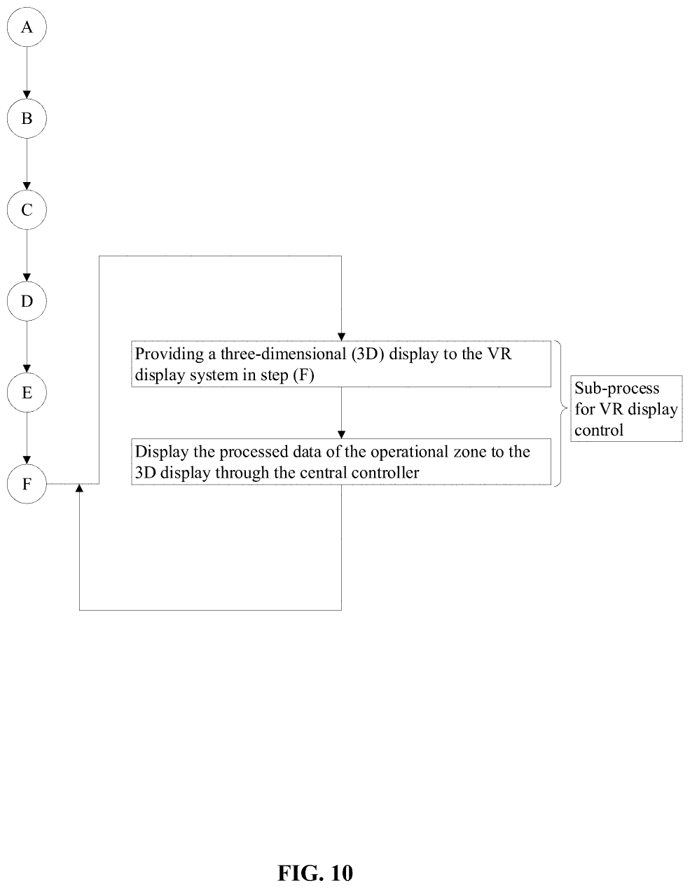

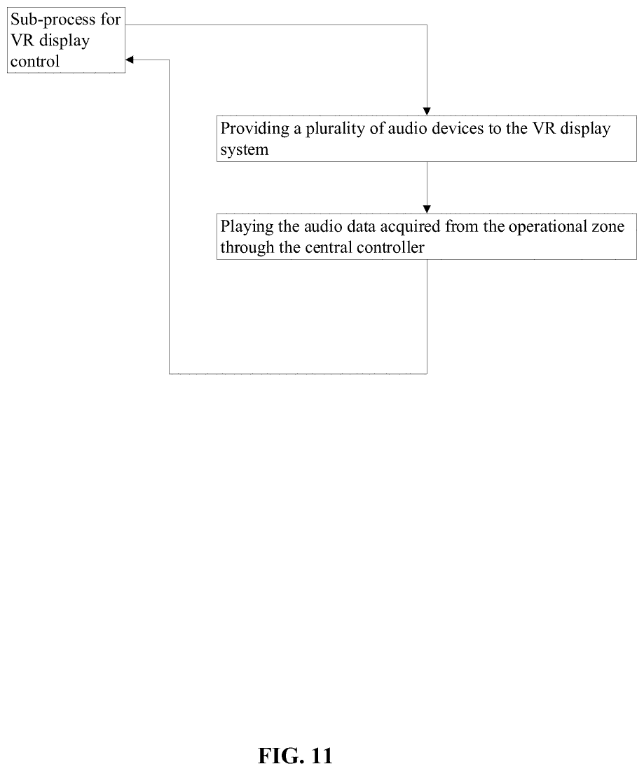

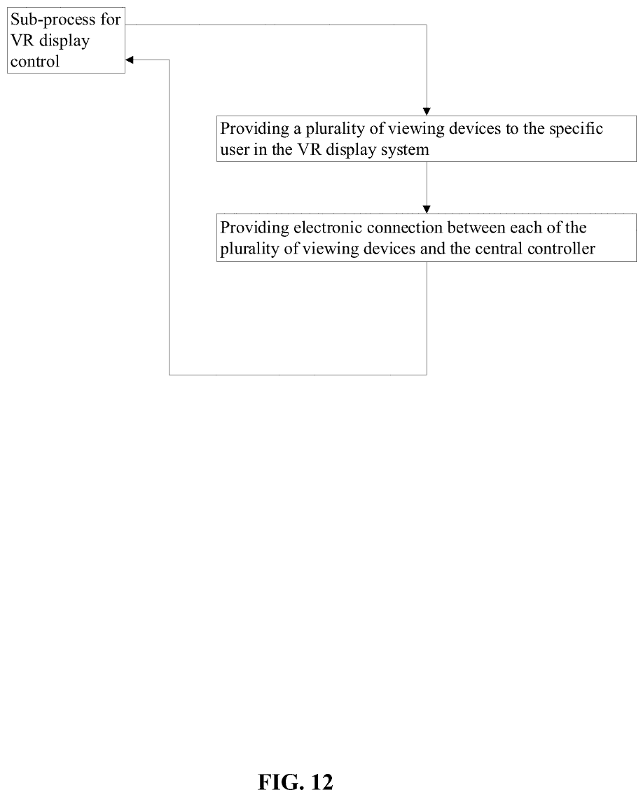

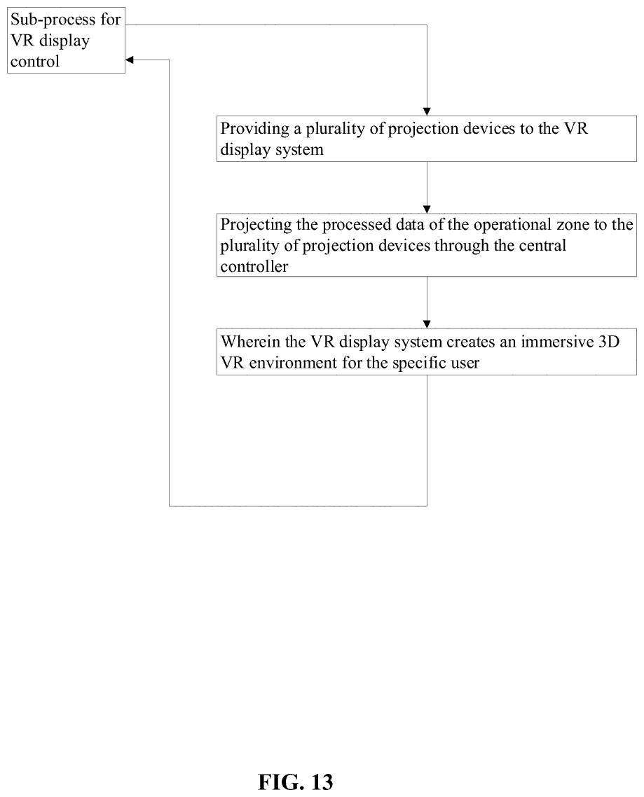

As can be seen in FIG. 10, the method provides a sub-process for VR display control. More specifically, the method provides a three-dimensional (3D) display to the VR display system in step (F). Subsequently, the method displays the processed data of the operational zone to the 3D display through the central controller. As can be seen in FIG. 11, in an alternative embodiment, the method provides a plurality of audio devices to the VR display system and plays the audio data acquired from the operational zone through the central controller. As can be seen in FIG. 12, in another embodiment, the method provides a plurality of viewing devices to the specific user in the VR display system. Additionally, the method provides electronic connection between each of the plurality of viewing devices and the central controller. As can be seen in FIG. 13, in another embodiment, the method provides a plurality of projection devices to the VR display system. Subsequently, the method projects the processed data of the operational zone to the plurality of projection devices through the central controller, wherein the VR display system creates an immersive 3D VR environment for the specific user. The plurality of sensors may include, but is not limited to, a plurality of light detection and ranging (LiDAR) sensors, etc. Further, the plurality of cameras may include, but is not limited to, a plurality of 3D 360° cameras.

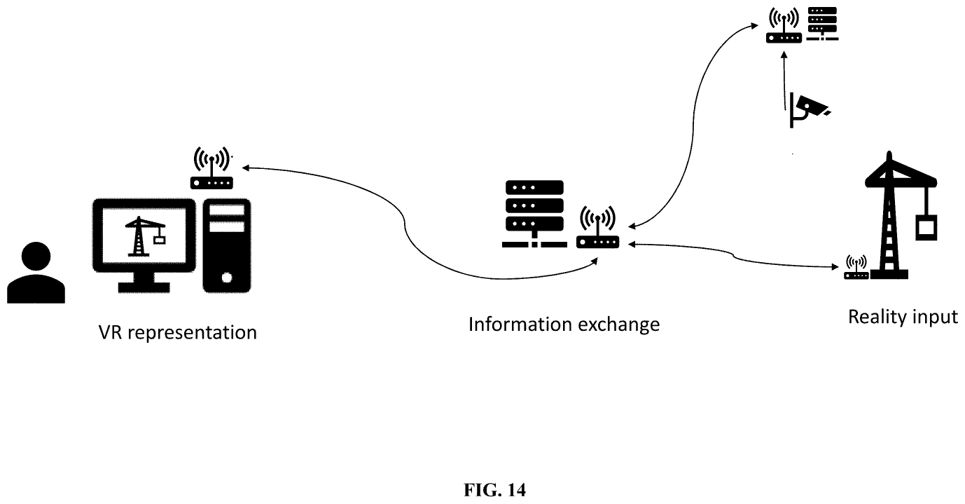

As shown in FIG. 14, in one embodiment, the method of the present invention provides multiple processors and robust memory, with most of the memory dedicated to instructions that, when executed by processors, initiate the data acquisition from the operational zone—also called “Reality Input”, data processing—also called “Information Exchange”, and VR display—also called “VR representation”. The instructions include routines, programs, objects, data structures, and the like. In some embodiments, the VR2R system can be implemented in a network environment, which can comprise one or more computing devices, servers, or one or more data stores and be communicatively connected via a network.

### Reality Input

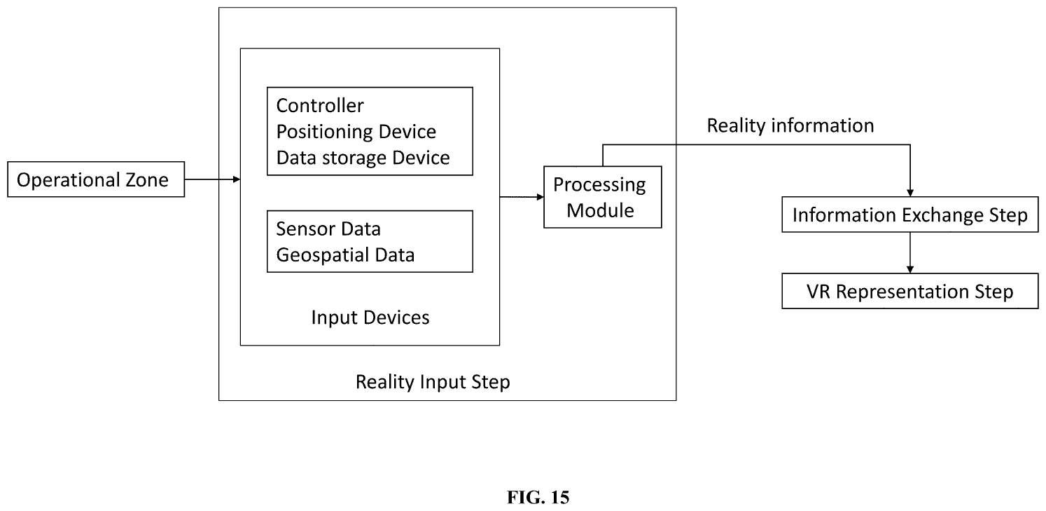

This reality input process, as shown in FIG. 15, may comprise a processing module to prepare reality information for an operational zone that can be represented in VR. The reality information includes the status of all aspect of the reality environment of the operational zone or portions thereof, for example, materials, control devices, real tools, equipment, or vehicles (hereinafter “real tools”). The processing module also includes programming instructions associated with the real environment and configured to transfer the reality information to the virtual environment via the information exchange step.

The processing module of the reality input step may be communicatively connected to various input devices, including a controller, positioning device, sensor data, geospatial data, and data storage device. The positioning device determines the time, location, and orientation of the tools. The positioning device may include one or more navigation systems, such as a global positioning system (GPS), an inertial navigation system, or other such location sensors. The sensor device may include devices for recording video, audio, and/or other geo-referenced data and can be provided on handheld devices (e.g., camera, personal digital assistant, portable computer, telephone), other equipment, or a vehicle.

Sensor devices may also include video and audio input devices that receive position and altitude information from the positioning device. Video input devices may include an analog or digital camera, a camcorder, a charged coupled device (CCD) camera, or any other image acquisition device. Audio input devices can include a microphone or other audio transducer that converts sounds into electrical signals. Sensor data sources are not limited to manned systems and may include other sources, such as remote surveillance video and satellite-based sensors. The video equipment can be a three-dimensional (3D) 360° camera, triangulation camera system, or any video system that can stream 360° video.

Geospatial data can include any source of geospatial data, for example, a geospatial information system (a.k.a. “GIS”), an interactive map system, or an existing database that contains location-based information.

The data storage device can be configured for storing software and data and may be implemented with a variety of components or subsystems, including a magnetic disk drive, an optical disk drive, flash memory, or other devices capable of storing information.

When the attributes (location, etc.) of the real-world object in the real world change, the changes can be detected by the camera and the information related to the change and can be transferred to the VR representation process to cause a corresponding change to one of the virtual scenes or the virtual object in the VR. For example, if the tool is moved or tilted in the real world, this information is obtained by the camera during the reality input step, and the camera provides the obtained information to the VR representation process. The determination of which change to apply to at least one of the virtual objects and the virtual scene is made through programming instructions associated with the virtual object and the virtual scene.

### Information Exchange

The information exchange step may include software located on one or more local and/or global servers. In one embodiment, the software can be configured to process video streams captured from the operational zone and project the video streams on the virtual canvas.

In some embodiments, for any real tool used in the real environment, the virtual copy (e.g., 3D objects) can be generated in advance. The virtual tool can be super-positioned with the video stream, as in the case of augmented reality, and it can be formatted to be displayed via a VR screening system, which will be described later.

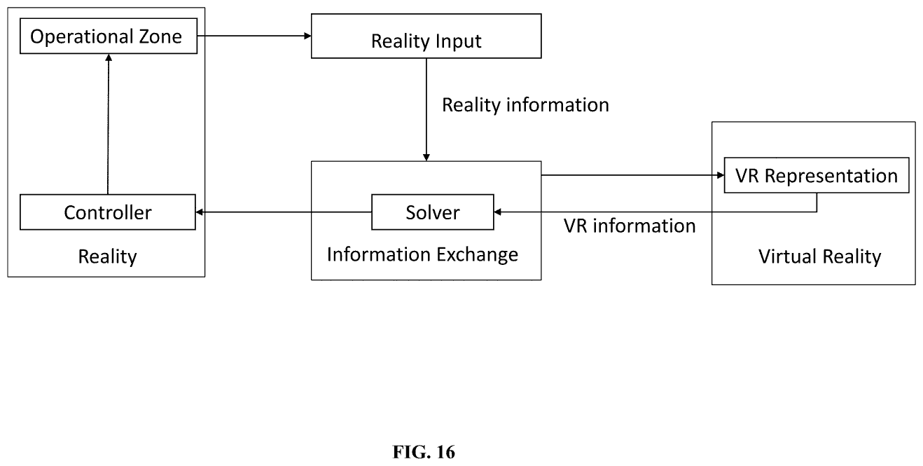

In some embodiments, as shown in FIG. 16, the information exchange step includes a solver that receives the VR information and represents it in the real environment in the operational zone via a controller (e.g., motion controller) that is included in the information exchange step. The solver may include a status analyzer that processes the input VR information into data (e.g. positional data) so that the controller can move the objects in the real environment to a position corresponding with the object in the virtual environment. In some embodiments, the real tool can be equipped with manipulation elements (steppers, actuators, etc.) controlled by a controller that is implemented as one or more data processing systems, including a computer, a personal computer, a minicomputer, a microprocessor, a workstation, a laptop computer, a hand-held computer, a personal digital assistant (PDA), or similar computer platform typically employed in the art.

### VR Representation

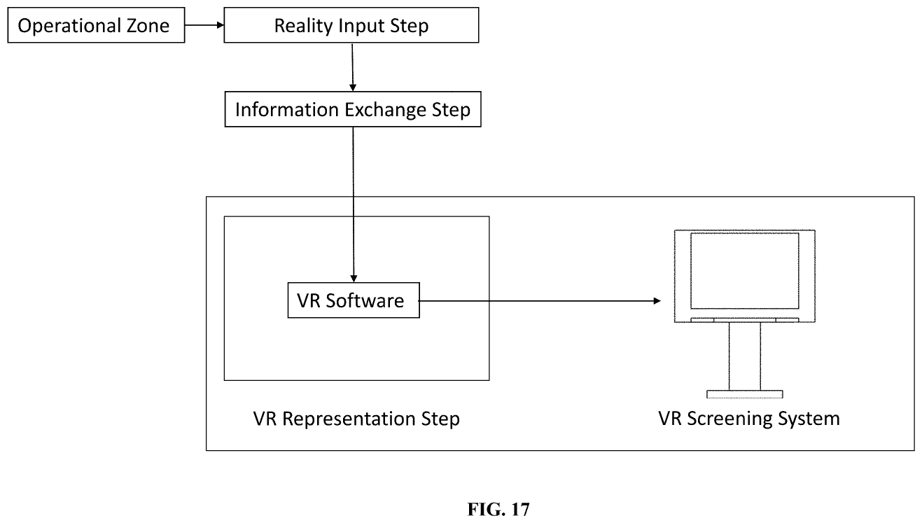

As shown in FIG. 17, the virtual reality representation (VRR) step may comprise VR software configured to receive data from the information exchange step and project them (e.g. streaming video data) to a VR screening system included in the VRR step and communicatively connected to the VR software.

When combined, the live stream video from the operational zone and pre-generated virtual tool can be projected to the VR screening system; the virtual tool can be aligned with the real tool. The user may then have visual information on the exact position of the tool in reality.

In some embodiments, the VR screening system can provide a three-dimensional or other immersive display of the environment, including the physical layout of that environment and a reproduction of the control system and apparatuses at the operational zone, for example, the controlled equipment, the materials, and/or other things processed by the apparatuses. In other embodiments, the VR screening system provides an immersive display of the environment that permits the user to experience interactions with the virtual environment.

The VR screening system may comprise various devices for communicating information to a user, including video and audio outputs. Video output can communicate with any device for displaying visual information, for example, a cathode ray tube (CRT), liquid crystal display (LCD), light emitting diode display (LED), plasma display, or electroluminescent display. Audio output may be a loudspeaker or any other transducer for generating audible sounds from electrical signals. That display can be conveyed to users via stereoscopic headgear of the type used for VR displays.

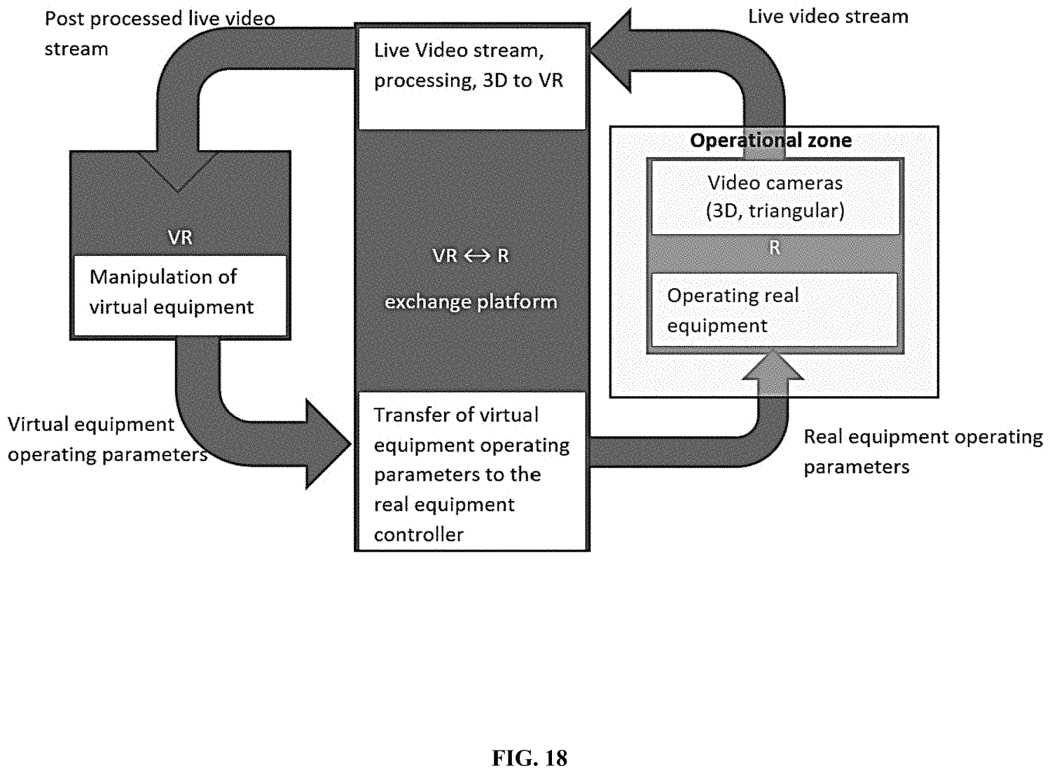

In some embodiments, the VRR step may include various VR controllers (e.g., wired gloves) that the user uses to manipulate the virtual tool. Any change in the virtual tool alignment will rewrite the virtual tool constraints that will be streamed in real time to the solver of the information exchange step for optimization. The optimized virtual tool constraints (or virtual equipment operating parameters) will be sent as new setup points to controllers of the real tool so that the real tool can be positioned corresponding to the virtual object's position, as shown in FIG. 18.

The VR controller(s) may include any device for communicating the user's commands to virtual reality, including a keyboard, keypad, computer mouse, touch screen, trackball, scroll wheel, joystick, television remote controller, or voice recognition controller.

The steps and the processes of a module described in connection with the embodiments disclosed herein can be embodied directly in hardware, in a software module executed by a processor, or in a combination of the two. A software module can reside in a memory unit that can include volatile memory, non-volatile memory, and network devices, or other data storage devices now known or later developed for storing information/data. The volatile memory may be any type of volatile memory including, but not limited to, static or dynamic, random access memory (SRAM or DRAM). The non-volatile memory may be any non-volatile memory including, but not limited to, ROM, EPROM, EEPROM, flash memory, and magnetically or optically readable memory or memory devices such as compact discs (CDs) or digital video discs (DVDs), magnetic tape, and hard drives.

The computing device may be a laptop computer, a cellular phone, a personal digital assistant (PDA), a tablet computer, and other mobile devices of the type. Communications between components and/or devices in the systems and methods disclosed herein may be unidirectional or bidirectional electronic communication through a wired or wireless configuration or network. For example, one component or device may be wired or networked wirelessly directly or indirectly, through a third-party intermediary, over the Internet, or otherwise with another component or device to enable communication between the components or devices. Examples of wireless communications include, but are not limited to, radio frequency (RF), infrared, Bluetooth, wireless local area network (WLAN) (such as WiFi), or wireless network radio, such as a radio capable of communication with a wireless communication network such as a Long Term Evolution (LTE) network, WiMAX network, 3G network, 4G network, and other communication networks of the type.

Although the invention has been explained in relation to its preferred embodiment, it is to be understood that many other possible modifications and variations can be made without departing from the spirit and scope of the invention as hereinafter claimed.

What is claimed is:

1. A method and system for displaying and controlling objects in an operational zone through a virtual reality system comprising the steps of:
(A) providing a central controller and a virtual reality (VR) display system, wherein the central controller is managed by at least one remote server, and wherein the VR display system is electronically connected to the central controller;
(B) providing a control system to an operational zone, wherein the control system is electronically connected to the central controller;
(C) providing a plurality of sensors and a plurality of cameras deployed in the operational zone, wherein both the plurality of sensors and the plurality of cameras are electronically connected to the control system;
(D) acquiring a plurality of data from each of the plurality of sensors and each of the plurality of cameras through the control system, wherein the plurality of data includes a plurality of point clouds and a plurality of video stream data;
(E) processing the plurality of data through the central controller, wherein the plurality of point clouds is converted to mapping data superimposed with the plurality of video stream data; and
(F) displaying the processed data onto the VR display system through the central controller.

2. The method and system for displaying and controlling objects in an operational zone through a virtual reality system as claimed in claim 1 comprising the steps of:
providing control of a plurality of objects in the operational zone through the control system in step (C);
wherein the control system is electronically connected to a plurality of objects in the operational zone; and
facilitating control of the plurality of objects through the control system, wherein the control system includes a control mechanism for each of the plurality of objects.

3. The method and system for displaying and controlling objects in an operational zone through a virtual reality system as claimed in claim 2 comprising the steps of:
acquiring geographic location data of the plurality of objects in the operational zone through the control system;
wherein the control system includes a plurality of global positioning systems; and
sending the geographic location data to the central controller.

4. The method and system for displaying and controlling objects in an operational zone through a virtual reality system as claimed in claim 2 comprising the steps of:
acquiring the current operating data of the plurality of objects through the control system;
wherein the plurality of objects includes a plurality of devices electronically connected to the control system;
sending the current operating data to the central controller through the control system;
making adjustments using a plurality of inputs from a specific user through the central controller;
sending the adjustments to the control system; and
making operating changes of the plurality of objects using the adjustments though the control system.

5. The method and system for displaying and controlling objects in an operational zone through a virtual reality system as claimed in claim 2 comprising the steps of:
wherein the plurality of objects includes a plurality of pieces of equipment.

6. The method and system for displaying and controlling objects in an operational zone through a virtual reality system as claimed in claim 2 comprising the steps of:
wherein the plurality of objects includes a plurality of tools.

7. The method and system for displaying and controlling objects in an operational zone through a virtual reality system as claimed in claim 2 comprising the steps of:
wherein the plurality of objects includes a plurality of robots.

8. The method and system for displaying and controlling objects in an operational zone through a virtual reality system as claimed in claim 2 comprising the steps of:
wherein the plurality of objects includes a plurality of motor vehicles.

9. The method and system for displaying and controlling objects in an operational zone through a virtual reality system as claimed in claim 1 comprising the steps of:
providing a plurality of user accounts managed by the at least one remote server in step (A), wherein each of the plurality of user accounts is associated with a corresponding personal computing (PC) device;
prompting the PC device of a specific user to connect to the central controller through the at least one remote server; and
facilitating the specific user's control over the plurality of objects in the operational zone using the central controller and the virtual reality display system through the corresponding PC device.

10. The method and system for displaying and controlling objects in an operational zone through a virtual reality system as claimed in claim 9 comprising the steps of:
providing a plurality of virtual reality (VR) controllers to the specific user in the VR display system;
wherein each of the plurality of VR controllers is electronically connected to the central controller; and
facilitating the specific user's control over the plurality of objects in the operational zone through the plurality of VR controllers in the VR display system.

11. The method and system for displaying and controlling objects in an operational zone through a virtual reality system as claimed in claim 9 comprising the steps of:
wherein the plurality of VR controllers includes a plurality of wired gloves.

12. The method and system for displaying and controlling objects in an operational zone through a virtual reality system as claimed in claim 9 comprising the steps of:
providing a solver to the central controller;
optimizing the operating data of the plurality of objects in the operating zone per the input from the plurality of VR controllers; and
facilitating the specific user's control over the plurality of objects in the operational zone through the central controller.

13. The method and system for displaying and controlling objects in an operational zone through a virtual reality system as claimed in claim 1 comprising the steps of:
providing a processing module to the control system of the operating zone in step (D);
pre-processing the data acquired from the plurality of sensors and plurality of cameras through the processing unit; and
sending the pre-processed data to the central controller before step (E).

14. The method and system for displaying and controlling objects in an operational zone through a virtual reality system as claimed in claim 1 comprising the steps of:
providing a three-dimensional (3D) display to the VR display system in step (F); and
display the processed data of the operational zone to the 3D display through the central controller.

15. The method and system for displaying and controlling objects in an operational zone through a virtual reality system as claimed in claim 14 comprising the steps of:
providing a plurality of audio devices to the VR display system; and
playing the audio data acquired from the operational zone through the central controller.

16. The method and system for displaying and controlling objects in an operational zone through a virtual reality system as claimed in claim 14 comprising the steps of:
providing a plurality of viewing devices to the specific user in the VR display system; and
providing electronic connection between each of the plurality of viewing devices and the central controller.

17. The method and system for displaying and controlling objects in an operational zone through a virtual reality system as claimed in claim 16 comprising the steps of:
wherein the plurality of viewing devices includes a plurality of VR headsets.

18. The method and system for displaying and controlling objects in an operational zone through a virtual reality system as claimed in claim 14 comprising the steps of:
providing a plurality of projection devices to the VR display system;
projecting the processed data of the operational zone to the plurality of projection devices through the central controller; and
wherein the VR display system creates an immersive 3D VR environment for the specific user.

19. The method and system for displaying and controlling objects in an operational zone through a virtual reality system as claimed in claim 1 comprising the steps of:
wherein the plurality of sensors includes a plurality of light detection and ranging (LiDAR) sensors.

20. The method and system for displaying and controlling objects in an operational zone through a virtual reality system as claimed in claim 1 comprising the steps of:
wherein the plurality of cameras includes a plurality of 3D 360° cameras.
